(19) United States
(12) Patent Application Publication
(10) Pub. No.: US 2025/0117454 A1
(43) Pub. Date: Apr. 10, 2025

(54) SYSTEMS AND METHODS FOR GENERATING DIGITAL RIGHTS MANAGEMENT ("DRM")-PROTECTED MEDIA VIA LAYERED MEDIA

(71) Applicant: Capital One Services, LLC, McLean, VA (US)

(72) Inventors: Shahalam BAIG, Rochester, NY (US); Oliver DEIGHTON, Vienna, VA (US); Hyunwoo KANG, New York, NY (US); Shasanka BHANDARI, McLean, VA (US); Matthew HUNSBERGER, Hoboken, NJ (US)

(73) Assignee: Capital One Services, LLC, McLean, VA (US)

(21) Appl. No.: 18/905,187

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10

(52) U.S. Cl. CPC G06F 21/106

(57) ABSTRACT

Described are systems and methods for generating digital rights management (“DRM”)-protected layered media, including receiving an indication of sensitive information, based on the indication of sensitive information, causing to output at least two layered security elements associated with the sensitive information, the at least two layered security elements including at least a first layer associated with a first security element and a second layer associated with a second security element, determining, via a browser module, digital extraction is indicated, upon determining digital extraction is indicated, modifying the first layer such that the first layer and the associated first security element are substantially transparent, and causing to output, via a first graphical user interface (“GUI”), the at least two layered security elements with the modified first layer, such that the second layer and the associated second security element are substantially visible.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, all of which are incorporated herein by reference in their entireties.

### TECHNICAL FIELD

Various embodiments of this disclosure relate generally to generating digital rights management (“DRM”)-protected media and, more particularly, to systems and methods for generating DRM-protected media via layered media.

### BACKGROUND

Organizations such as banks and healthcare providers seek to protect sensitive or confidential information (e.g., personally identifiable information (“PII”), financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may attempt to persuade the user to reveal the account number to the social engineer. More specifically, the social engineer may convince the user to (i) share the user's screen (displaying the account number) with the social engineer using a screen sharing or remote desktop application, or (ii) take a screenshot of the user's screen (displaying the account number) using a screenshotting application, and then transmit the screenshot to the social engineer.

To guard against such social engineering, the bank may employ digital rights management (“DRM”) technologies, which are technologies that limit the use of digital content. However, current DRM technologies may not be configured to modify security measures in real time based on the detection of attempted digital extraction (e.g., screen sharing, screenshotting, etc.).

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating DRM-protected media via layered media.

In one aspect, a method for generating digital rights management (“DRM”)-protected layered media is disclosed. The method may include receiving, via a browser module, an indication of sensitive information, the indication of sensitive information having been determined based on a content element, based on the indication of sensitive information, causing to output at least two layered security elements associated with the sensitive information, the at least two layered security elements including at least a first layer associated with a first security element and a second layer associated with a second security element, determining, via a browser module, digital extraction is indicated, upon determining digital extraction is indicated, modifying the first layer such that the first layer and the associated first security element are substantially transparent, and causing to output, via a first graphical user interface (“GUI”), the at least two layered security elements with the modified first layer, such that the second layer and the associated second security element are substantially visible.

In another aspect, a system is disclosed. The system may include at least one memory storing instructions and at least one processor operatively connected to the memory, and configured to execute the instructions to perform operations for generating digital rights management (“DRM”)-protected layered media. The operations may include receiving, via a browser module, an indication of sensitive information, the indication of sensitive information having been determined based on a content element, based on the indication of sensitive information, causing to output at least two layered security elements associated with the sensitive information, the at least two layered security elements including at least a first layer associated with a first security element and a second layer associated with a second security element, determining, via a browser module, digital extraction is indicated, upon determining digital extraction is indicated, modifying the first layer such that the first layer and the associated first security element are substantially transparent, and causing to output, via a first graphical user interface (“GUI”), the at least two layered security elements with the modified first layer, such that the second layer and the associated second security element are substantially visible.

In another aspect, a method for generating digital rights management (“DRM”)-protected layered media is disclosed. The method may include receiving, via a browser module, an indication of sensitive information, the indication of sensitive information having been determined based on a content element, based on the indication of sensitive information, causing to output at least two layered security elements associated with the sensitive information, the at least two layered security elements including: a first layer associated with a first security element, wherein the first security element is a DRM-protected security element including at least one of a single frame-looped video that substantially matches formatting associated with a media content background or a first user interface element, a second layer associated with a second security element, wherein the second security element is a non-DRM-protected security element including at least one of a natural language message, a HyperText Markup Language div element, second user interface element, or a Completely Automated Public Turing test to tell Computers and Humans Apart (“CAPTCHA”), and a third layer including the media content background, determining, via a browser module, digital extraction is indicated, upon determining digital extraction is indicated, dynamically generating the second security element based on the indication of digital extraction via the browser module, wherein the generated second security element is incorporated into the second layer, upon determining digital extraction is indicated, modifying the first layer such that the first layer and the associated first security element are substantially transparent, causing to output, via a first graphical user interface (“GUI”), the at least two layered security elements with the modified first layer, such that the second layer and the associated second security element are substantially visible, receiving a user input associated with the second security element, transmitting the user input to an analysis system, and based on the user input, initiating at least one protective measure via the analysis system, wherein the at least one protective measure includes at least one of pausing a current transaction, pausing subsequent transactions, or locking an account associated with the sensitive information.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for generating DRM-protected media via layered media, according to one or more embodiments.

FIGS. 2A-2B depict exemplary methods for generating DRM-protected media via layered media, according to one or more embodiments.

FIGS. 3A-3B depict exemplary schematics for generating DRM-protected media via layered media, according to one or more embodiments.

FIGS. 4A-4D depict exemplary schematics for generating DRM-protected media via layered media, according to one or more embodiments.

FIGS. 5A-5B depict exemplary schematics for generating DRM-protected media via layered media, according to one or more embodiments.

FIG. 6 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

As used herein, the phrase “media content” may represent a browser, a website, a webpage, etc. As used herein, the phrase “content element” may represent text data (e.g., letters, numbers, symbols, metadata, or alt text), image data (e.g., an image, a graphic, a sequence of image frames, or a video), audio data (e.g., a sequence of audio frames), or video data (e.g., a sequence of image frames). Further, a content element may represent data included in, or referred by, an HTML element of an HTML page corresponding to (or representing) the webpage. For example, a content element may be included in HTML used to structure the website, such as a Document Object Model (“DOM”), Cascading Style Sheets (“CSS”), etc. In some aspects, the content element may include or represent sensitive or confidential information (e.g., that may be displayed on a webpage (or webpage(s), website(s), portal(s) or application(s), etc.).

As used herein, the phrase “sensitive information” or “sensitive data” may refer to data that is intended for, or restricted to the use of, one or more users or entities (e.g., a user 105, an organization associated with a DRM-protection system 131, etc.). Moreover, sensitive data may represent data that is personal, private, confidential, privileged, secret, classified, or in need of protection, for example. Sensitive information may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

The phrase “hypertext markup language,” “HTML,” or the like may refer to a standardized system for tagging text files to achieve font, color, graphic, or hyperlink effects on World Wide Web pages. The phrase “HTML element” may represent a component of an HTML page, and may include, for example, a start tag and end tag, and as noted above, a content element or a reference to a content element (e.g., link, hyperlink, address, or path to a content element). Further, in some embodiments, an HTML element may include one or more HTML elements (e.g., nested HTML elements). As used herein, the term “pixel” may refer to the smallest element (or unit) of a display screen that can be programmed by (or manipulated through) software. In some embodiments, a pixel may include sub-pixels (e.g., a red sub-pixel, a green sub-pixel, and a blue sub-pixel) that emit light to create a color displayed on the display screen. In some aspects, the color may be included in, or represent, text data, image data, or video data presented on the display screen.

A security element may include a device for authentication, such as a Completely Automated Public Turing test to tell Computers and Humans Apart (“CAPTCHA”)®, security key, password, single sign-on (“SSO”), or any other suitable authentication or security method. As used herein, the phrase “digital extraction” may refer to any process of copying content (e.g., audio, video, text, image, etc.), such as ripping, screensharing, screenshotting, etc. As used herein, the term “screenshare” or “screen share” may refer to a real time or near real time electronic transmission of data displayed on a display screen of a user's computing device to one or more other computing devices. The term “screensharing” or “screen sharing” and the phrase “being screenshared” or “being screen shared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” or “screen shot” may represent an image of data displayed on a display screen of a computing device, where the image may be captured or recorded. The term “screenshotting” or “screen shotting” and the phrase “being screenshotted” or “being screen shotted” may refer to capturing or recording a screenshot. In some aspects, screenshotting may be performed using a screenshotting application (e.g., the Snipping Tool in Microsoft's Windows 11 or an application accessed using a Print Screen key of a keyboard or keypad).

In a first exemplary use case, a user may wish to protect sensitive information from digital extraction. In some embodiments, a website, a webpage, an application, etc. may be configured to output layered security measures over sensitive information. For example, if a user's social security number is displayed on a webpage, the layered security measures may be output such that they are overlaid on the social security number. The layered security measures may include any suitable number of layers. For example, in some embodiments, the layered security measures may include a first layer, a second layer, and a third layer. The first layer may be a digital rights management (“DRM”)-protected layer with an associated first security element. The second layer may be a non-DRM-protected layer with an associated second security element. The third layer may substantially match the background of the media content. The first layer, the second layer, or the third layer may be layered such that the second layer is overlaid on the third layer, and the first layer is overlaid on the second layer.

If digital extraction is not detected, the layered security measures may display the first layer and the associated first security element. The user may provide a first user input based on the first security element. Data associated with the first user input may be transmitted to an analysis system, such as the DRM-protection system discussed in more detail herein.

If digital extraction is detected, the layered security measures may display the second layer and the associated second security element. In response to detecting an indication of digital extraction, the first layer and the associated first security element may be made substantially transparent, such that the second layer and the associated second security element may be made substantially visible. The user may provide a second user input based on the second security element. The second user input may be transmitted to the analysis system. The analysis system may generate a first alert based on the second user input. The first alert may be output to a first graphical user interface (“GUI”) associated with a user device. The analysis system may generate a second alert based on the second user input. The second alert may be output to a GUI associated with the analysis system, such as a third-party security system.

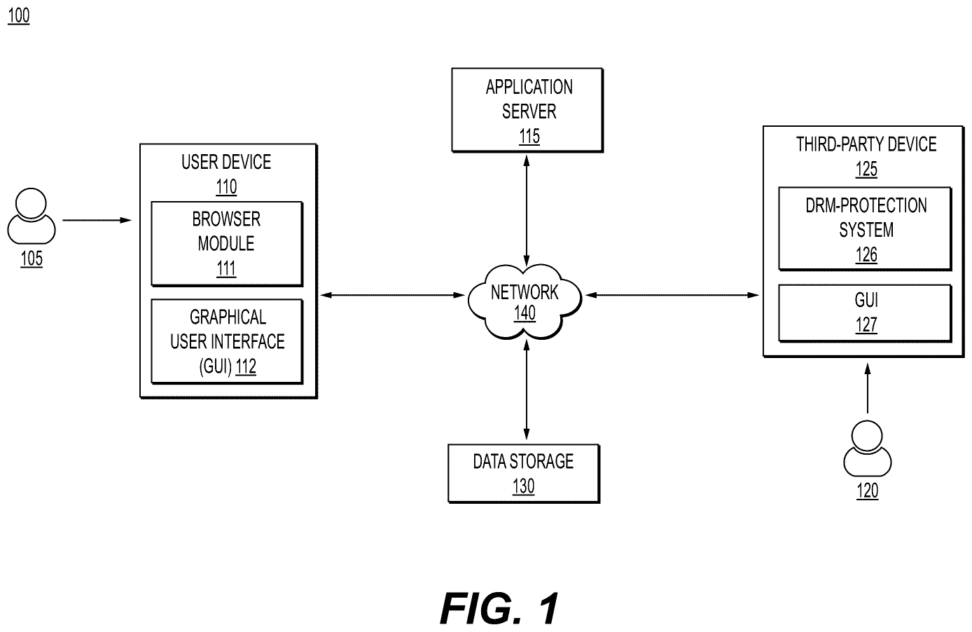

FIG. 1 depicts an example environment 100 that may be utilized with techniques presented herein. In some aspects, the environment 100 may be an embodiment of (i) the environment 100 described in U.S. Provisional Application 63/587,891, filed on Oct. 4, 2023, (ii) the environment 100 described in U.S. Provisional Application 63/665,485, filed on Jun. 28, 2024, or (iii) the environment 100 described in U.S. Provisional Patent Application No. 63/683,063, filed Aug. 14, 2024 where each of these U.S. provisional applications is incorporated by reference herein in its entirety. FIG. 1 depicts an exemplary environment 100 for generating digital rights management (“DRM”)-protected media via layered media, according to one or more embodiments. Environment 100 may include one or more aspects that may communicate with each other over a network 140, including, e.g., at least one memory storing instructions, and at least one processor operatively connected to the at least one memory and configured to execute the instructions to perform operations for generating DRM-protected media via layered media.

In some embodiments, a user 105 may interact with a user device 110 such that media content (e.g., a browser, a website, a webpage, etc.) including at least one content element may be loaded. As discussed herein, the at least one content element may be associated with sensitive information. As depicted in FIG. 1, a user 105 may be an individual authorized to use, access, etc. user device 110 or access, view, etc. the sensitive information discussed herein. User device 110 may interact with at least one of an application server 115, a third-party device 125, a data storage 130, etc. User device 110 may be configured to enable user 105 to access or interact with other systems in environment 100.

In some embodiments, a third-party user 120 may interact with a third-party device 125 such that information associated with digital extraction may be managed. A user 120 may be an individual associated with a third party, such as a third party facilitating, monitoring, etc. the DRM protections discussed herein. Third-party device 125 may be configured to enable third-party user 120 to access or interact with other systems in environment 100.

In some embodiments, user device 110 or third-party device 125 may be a computer system, e.g., a desktop computer, a laptop computer, a tablet, a smart cellular phone, a smart watch or other electronic wearable, etc. In some embodiments, user device 110 or third-party device 125 may include one or more electronic applications, e.g., a program, plugin, browser extension, etc., installed on a memory of user device 110 or third-party device 125. In some embodiments, the electronic applications may be associated with one or more of the other components in the environment 100.

User device 110 may include a browser module 111 or a graphical user interface (“GUI”) 112. User device 110—or the one or more aspects of user device 110, e.g., browser module 111, GUI 112, etc.—may be configured to obtain data from one or more aspects of environment 100. For example, user device 110 may be configured to receive data from browser module 111, GUI 112 (e.g., via one or more inputs from user 105), application server 115, third-party device 125, DRM-protection system 126, GUI 127 (e.g., via one or more inputs from third-party user 120), data storage 130, etc. User device 110 may be configured to transmit data to one or more aspects of environment 100, e.g., to browser module 111, GUI 112, application server 115, third-party device 125, DRM-protection system 126, GUI 127, data storage 130, etc.

Browser module 111 may be configured to detect loading of media content, a content element, etc. For example, user 105 may operate user device 110 to load media content (e.g., a website). Browser module 111 may be configured to detect or receive an indication of the request for media content to be loaded. In some embodiments, browser module 111 may be configured to detect or receive the request for at least one content element (e.g., a first content element, a second content element, a third content element, etc.) associated with media content to be loaded.

Browser module 111 may be configured to determine an indication of sensitive information. The indication of sensitive information may include data related to the sensitive information associated with the content element. In some embodiments, the indication of sensitive information may include data indicating that the content element includes sensitive information. In some embodiments, the indication of sensitive information may include data indicating the format (e.g., text, image, video, audio, etc.), category (PII, financial information, medical information, business information, government information, etc.), etc. of the sensitive information. For example, the indication of sensitive information may include data indicating that the sensitive information is textual and an account balance.

Browser module 111 may be configured to determine digital extraction is indicated. In some embodiments, browser module 111 may be configured to detect, analyze, or transmit (e.g., to application server 115) an indication of digital extraction (e.g., screensharing, screenshotting, screen capture, etc.). In some embodiments, browser module 111 may be configured to receive the indication of digital extraction from other aspects of environment 100, such as user device 110, application server 115, data storage 130, etc. In some embodiments, browser module 111 may be configured to detect digital extraction based on indirect measures of digital extraction. For example, browser module 111 may be configured to detect user input(s) that may be indicative of screenshotting, such as simultaneously pressing and releasing the lock button and the volume up button on a social engineer's user device. In some embodiments, browser module 111 may be configured to infer or predict digital extraction may be occurring. For example, browser module 111 may be configured to determine a screensharing application, such as Zoom®, may be operating on a user device (e.g., user device 110) while a user (e.g., user 105) is accessing sensitive information. Browser module 111 may be configured to determine the indication of digital extraction based on the simultaneous operation of the screensharing application and the accessing sensitive information on user device 110.

Browser module 111 may be configured to obtain data from one or more aspects of environment 100. For example, browser module 111 may be configured to receive data from user device 110, GUI 112 (e.g., via one or more inputs from user 105), application server 115, third-party device 125, DRM-protection system 126, GUI 127 (e.g., via one or more inputs from third-party user 120), data storage 130, etc. Browser module 111 may be configured to transmit data to one or more aspects of environment 100. For example, browser module 111 may be configured to transmit data to user device 110, GUI 112, application server 115, third-party device 125, DRM-protection system 126, GUI 127, data storage 130, etc.

GUI 112 may be configured to cause to output the at least two layered security elements associated with the sensitive information. In some embodiments, GUI 112 may cause to output the at least two layered security elements in a pre-determined order. For example, GUI 112 may be configured to output a third layer under a second layer, and a second layer under a first layer, such that only the first layer is visible when caused to be output. When digital extraction is not indicated, GUI 112 may be configured to cause to output the at least two layered security elements based on the pre-determined order.

In some embodiments, where digital extraction is indicated, GUI 112 may be configured to cause to output the at least two layered security elements with the modified first layer. As discussed herein, the modified first layer may be the first layer (and the associated first security element) modified to be substantially transparent. GUI 112 may be configured to cause to output the at least two layered security elements with the modified first layer such that the second layer (and associated second security element) are substantially visible.

GUI 112 may be configured to receive at least one user input. In some embodiments, GUI 112 may be configured to receive a first user input associated with a first security element, a second user input associated with a second security element, a third user input associated with a third security element, etc.

GUI 112 may be configured to cause to output the at least one alert (e.g., a first alert, a second alert, a third alert, etc.), etc. GUI 112 may be configured to receive the at least one alert from other aspects of environment 100, such as application server 115, third-party device 125, DRM-protection system 126, etc.

GUI 112 may be configured to obtain data from one or more aspects of environment 100. For example, GUI 112 may be configured to receive data from user device 110, browser module 111, application server 115, third-party device 125, DRM-protection system 126, GUI 127 (e.g., via one or more inputs from third-party user 120), data storage 130, etc. GUI 112 may be configured to transmit data to one or more aspects of environment 100. For example, GUI 112 may be configured to transmit data to user device 110, browser module 111, application server 115, third-party device 125, DRM-protection system 126, GUI 127, data storage 130, etc.

Application server 115 may be configured to dynamically generate the at least two layered security elements associated with the sensitive information. Application server 115 may be configured to generate the at least two layered security elements with at least a first layer and a second layer. In some embodiments, application server 115 may be configured to generate the at least two layered security elements with a plurality of layers, e.g., a first layer, a second layer, a third layer, etc.

Application server 115 may be configured to generate the first layer to include a first security element. The first security element may be a DRM-protected security element including at least one of a single frame-looped video that substantially matches formatting associated with the media content background of the third layer or a first user interface element. The first user interface element may be at least one of a DRM-protected button, a DRM-protected toggle, a DRM-protected CAPTCHA®, a DRM-protected HTML div element, a DRM-protected image, etc. In some embodiments, the first layer and first security element may be substantially visible when digital extraction is not indicated. For example, where the at least two layered security elements include a first layer and a second layer and digital extraction is not indicated, the first layer (and associated first security element) may be substantially opaque such that, when caused to be output via a GUI (e.g., GUI 112), the first layer (and associated first security element) are visible and the second layer (and associated second security element) are not visible.

Application server 115 may be configured to generate the second layer to include a second security element. The second security element may be a non-DRM-protected security element including at least one of a natural language message, an HTML div element, or a second user interface element. The natural language message may include a message to the user (e.g., user 105), such as a warning message (e.g., “Your data may be at risk”), a watermark (e.g., a watermarked image), etc. The HTML div element may be generated using the CSS properties z-index and position, such that the HTML div element substantially matches a background color of the media content (e.g., webpage, etc.). The second user interface element may be at least one of a button, a toggle, a CAPTCHA®, etc. In some embodiments, the second layer and second security element may be substantially visible when digital extraction is indicated. For example, where the at least two layered security elements include a first layer and a second layer and digital extraction is indicated, the first layer (and associated first security element) may be substantially transparent such that, when caused to be output via a GUI (e.g., GUI 112), the second layer (and associated second security element) are visible and the first layer (and associated first security element) are not visible.

Application server 115 may be configured to generate the third layer based on the formatting of the media content, such as the background design, color, opacity, etc. For example, if the media content background color is white, application server 115 may be configured to generate the third layer such that the third layer includes a white background.

Application server 115 may be configured to dynamically generate at least one layer of the at least two layered security elements based on the indication of digital extraction. In some embodiments, upon receipt of the indication of digital extraction, application server 115 may be configured to dynamically generate the second layer and associated second security element of the at least two layered security elements. For example, application server 115 may be configured to generate the second security element to include a natural language warning message upon receipt of the indication of digital extraction. In a further example, application server 115 may be configured to modify a first security element to generate a second security element. For example, if the first security element includes a first natural language message, application server 115 may be configured to modify the first natural language message of the first security element to generate a second natural language message for the second security element. Application server 115 may be configured to generate the second layer based on the generated second security element.

Application server 115 may be configured to incorporate the generated second layer (and associated generated second security element) into the at least two layered security elements such that when the first layer is modified (e.g., to be substantially transparent, as discussed elsewhere herein), the generated second layer and the associated second security element are substantially visible when caused to be output via the first GUI (e.g., GUI 112).

Application server 115 may be configured to modify the at least two layered security elements. In some embodiments, upon receipt of the indication of digital extraction, application server 115 may be configured to modify the first layer of the at least two layered security elements. Application server 115 may be configured to modify the first layer by making the first layer (and associated first security element) substantially transparent (e.g., when caused to be output via GUI 112), pausing the DRM-protected media of the first layer (e.g., pausing, stopping, etc. the single frame-looped video), etc. For example, the first layer and associated first security element may be about 70%-80%, about 80%-90%, about 90%-99%, etc. transparent. It may be advantageous for the media to be less than 100% transparent because the DRM protection techniques may fail to completely render media that is 100% transparent, and therefore may fail to effectively block the 100% transparent media. Upon application server 115 modifying the first layer, the second layer (and associated second security element) may become substantially visible when caused to be output via GUI 112.

Application server 115 may be configured to generate at least one alert (e.g., a first alert, a second alert, a third alert, etc.) based on the intended recipient. The first alert may be generated based on the user (e.g., user 105) being the intended recipient. For example, the first alert may be generated to include a natural language message for user 105 (e.g., “Your data may be at risk,” “Your information may be exposed,” etc.). The second alert may be generated based on the user (e.g., user 120) being the intended recipient. For example, the second alert may be generated to include a natural language message for user 120 (e.g., “User A's data may be compromised,” etc.).

Application server 115 may be configured to generate the at least one alert (e.g., the first alert, the second alert, the third alert, etc.) based on the indication of digital extraction. For example, the third alert may be generated to include a natural language message that digital extraction may be indicated. In some embodiments, the third alert may be transmitted to one or more intended recipient, such as user 105 (e.g., to GUI 112) or third-party user 120 (e.g., to GUI 127).

Application server 115 may be configured to generate the at least one alert (e.g., the first alert, the second alert, the third alert, etc.) based on at least one user input (e.g., a first user input, a second user input, etc.). For example, application server 115 may be configured to generate the at least one alert based on the first user input received in association with the first security element. In a further example, application server 115 may be configured to generate the at least one alert based on the second user input received in association with the second security element.

Application server 115 may be configured to obtain data from one or more aspects of environment 100. For example, application server 115 may be configured to receive data from user device 110, browser module 111, GUI 112 (e.g., via one or more inputs from third-party user 105), third-party device 125, DRM-protection system 126, GUI 127 (e.g., via one or more inputs from third-party user 120), data storage 130, etc. Application server 115 may be configured to transmit data to one or more aspects of environment 100. For example, application server 115 may be configured to transmit data to user device 110, browser module 111, GUI 112, third-party device 125, DRM-protection system 126, GUI 127, data storage 130, etc.

Third-party device 125 may be configured to enable user 120 to access or interact with other systems in the environment 100. Third-party device 125 may include a digital rights management (“DRM”)-protection system 126 or a GUI 127. Third-party device 125—or the one or more aspects of third-party device 125, e.g., DRM-protection system 126, GUI 127, etc.—may be configured to obtain data from one or more aspects of environment 100. For example, third-party device 125 may be configured to receive data from user device 110, browser module 111, GUI 112 (e.g., via one or more inputs from user 105), application server 115, DRM-protection system 126, GUI 127 (e.g., via one or more inputs from user 120), data storage 130, etc. Third-party device 125 may be configured to transmit data to one or more aspects of environment 100, e.g., to user device 110, browser module 111, GUI 112 (e.g., via one or more inputs from user 105), application server 115, DRM-protection system 126, GUI 127 (e.g., via one or more inputs from user 120), data storage 130, etc.

DRM-protection system 126 may be configured to implement at least one protective measure. The at least one protective measure may be configured to protect (or safeguard) a content element, sensitive information, etc. The at least one protective measure may include at least one of pausing, locking, canceling, etc. an account (e.g., a financial account) associated with the sensitive information, pausing a current financial transaction, pausing subsequent financial transactions, transmitting the at least one alert (e.g., to GUI 112), etc. In some embodiments, DRM-protection system 126 may be configured to implement the at least one protective measure based on at least one of the indication of digital extraction, the at least one alert (e.g., the first alert, the second alert, the third alert, etc.), etc. For example, where the content element represents a checking account number, DRM-protection system 126 may be configured to lock (or freeze) the checking account associated with the checking account number as a precautionary measure.

DRM-protection system 126 may be configured to generate the at least one alert (e.g., the first alert, the second alert, the third alert, etc.) based on at least one user input (e.g., a first user input, a second user input, etc.). For example, DRM-protection system 126 may be configured to generate the at least one alert based on the first user input received in association with the first security element. In a further example, DRM-protection system 126 may be configured to generate the at least one alert based on the second user input received in association with the second security element.

DRM-protection system 126 may be configured to analyze the at least one user input to predict whether digital extraction may be indicated. For example, DRM-protection system 126 may be configured to determine digital extraction may not be indicated if a first user input associated with the first security element is received. In a further example, DRM-protection system 126 may be configured to determine digital extraction may be indicated if a second user input associated with the second security element is received. In some embodiments, DRM-protection system 126 may be configured to detect bots. Bot detection is a process that may identify or block malicious bots from websites, applications, networks, etc. while allowing legitimate users to access them. Bot detection tools may analyze a variety of user and website attributes to determine if a visitor is a bot.

DRM-protection system 126 maybe configured to obtain data from one or more aspects of environment 100. For example, DRM-protection system 126 may be configured to receive data from user device 110, browser module 111, GUI 112 (e.g., via one or more inputs from user 105), application server 115, third-party device 125, GUI 127 (e.g., via one or more inputs from user 120), data storage 130, etc. DRM-protection system 126 may be configured to transmit data to one or more aspects of environment 100, e.g., to user device 110, browser module 111, GUI 112, application server 115, third-party device 125, GUI 127, data storage 130, etc.

GUI 127 may be configured to output the at least one alert (e.g., the first alert, the second alert, the third alert, etc.). For example, GUI 127 may be configured to output the second alert. User 120 may interact with the second alert via GUI 127. GUI 127 may be configured to output the at least two layered security elements (e.g., with the first layer visible, with the second layer visible, with the third layer visible, etc.).

GUI 127 maybe configured to obtain data from one or more aspects of environment 100. For example, GUI 127 may be configured to receive data from user device 110, browser module 111, GUI 112 (e.g., via one or more inputs from user 105), application server 115, third-party device 125, DRM-protection system 126, data storage 130, etc. GUI 127 may be configured to transmit data to one or more aspects of environment 100, e.g., to user device 110, browser module 111, GUI 112, application server 115, third-party device 125, DRM-protection system 126, data storage 130, etc.

Data storage 130 may be configured to cache the layers of the at least two layered security elements (e.g., the first layer and the associated first security element, the second layer and the associated second security element, the modified second layer and the associated modified second security element, the generated second layer and the associated generated second security element, the third layer, etc.), the at least one user input (e.g., the first user input, the second user input, etc.), etc.

Data storage 130 may be configured to receive data from other aspects of environment 100, such as from user device 110, browser module 111, GUI 112 (e.g., via one or more inputs from user 105), application server 115, third-party device 125, DRM-protection system 126, GUI 127 (e.g., via one or more inputs from user 120), etc. Data storage 130 may be configured to transmit data to other aspects of environment 100, such as to user device 110, browser module 111, GUI 112, application server 115, third-party device 125, DRM-protection system 126, GUI 127, etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, application server 115 may be integrated in browser module 111. In some embodiments, operations or aspects of one or more of the components discussed above may be distributed amongst one or more other components, e.g., one or both of browser module 111 or application server 115.

In some embodiments, some of the components of environment 100 may be associated with a common entity, while others may be associated with a disparate entity. For example, browser module 111 and application server 115 may be associated with a common entity (e.g., an entity with which user 105 has an account) while data storage 130 may be associated with a third party (e.g., a provider of data storage services). Any suitable arrangement or integration of the various systems and devices of the environment 100 may be used.

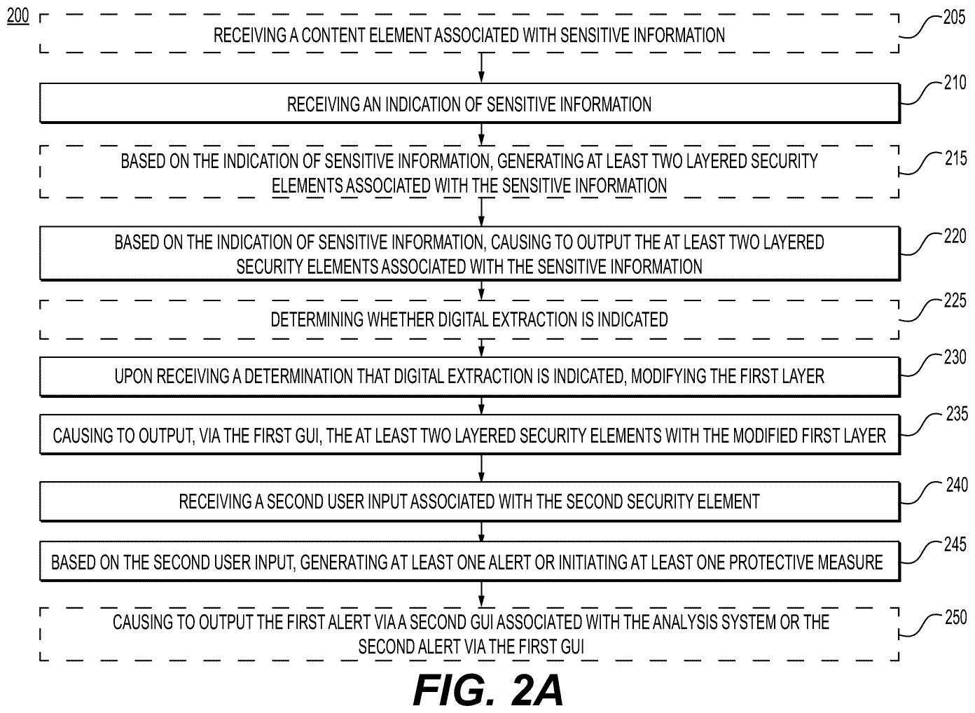

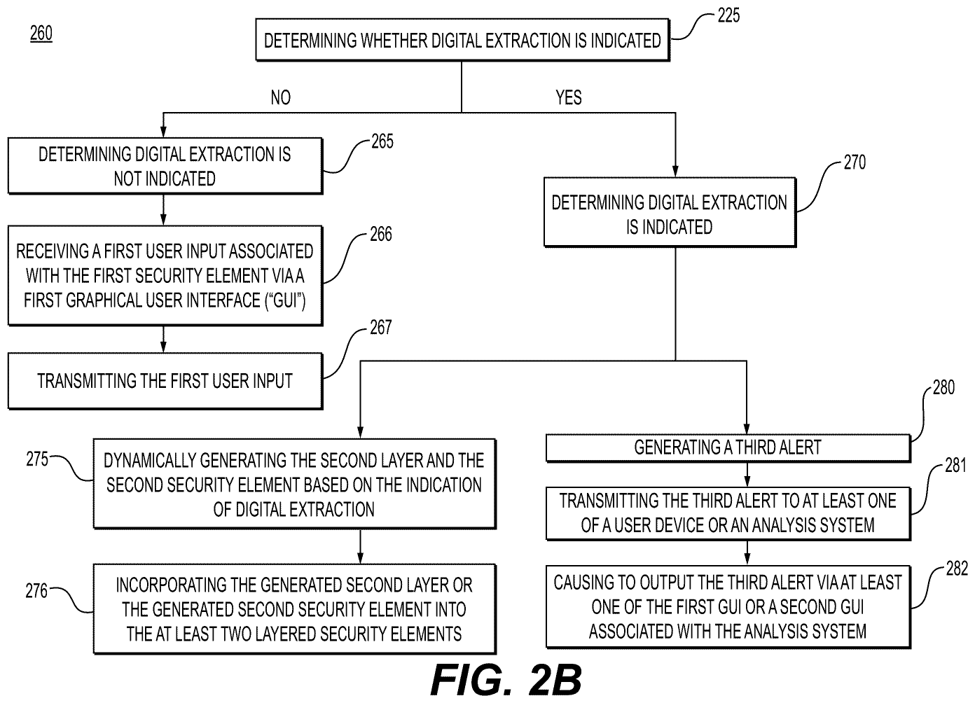

FIGS. 2A-2B depict exemplary methods for generating DRM-protected layered media, according to one or more embodiments. As depicted in method 200 of FIG. 2A, optionally at step 205, a content element associated with sensitive information may be received (e.g., via browser module 111). In some embodiments, the content element may be received in response to a user (e.g., user 105) loading media content (e.g., a webpage).

At step 210, an indication of sensitive information may be received (e.g., via browser module 111). As discussed herein, the indication of sensitive information may include the sensitive information associated with the content element or data indicating the format, category, etc. of the sensitive information. For example, the indication of sensitive information may include data indicating that the sensitive information is textual, is an account balance, and the account balance is $12,345.

Optionally, at step 215, at least two layered security elements associated with the sensitive information may be generated based on the indication of sensitive information (e.g., via application server 115). As discussed herein, the at least two layered security elements may be generated to include at least a first layer and a second layer. In some embodiments, the at least two layered security elements may be generated to include a plurality of layers, e.g., a first layer, a second layer, a third layer, etc. In some embodiments, the at least two layered security elements may be generated to include any suitable combination or order of layers, such as a first layer and a third layer; the first layer and a second layer; the second layer and the third layer; the first layer, the second layer, and the third layer; etc.

The first layer may be generated to include a first security element, and the first security element may be DRM-protected. In some embodiments, the first security element may be a looped single-frame DRM-protected video that substantially matches the background color of the media content (e.g., website). The first security element may further include a first user interface element. The first user interface element may be at least one of a DRM-protected button, a DRM-protected toggle, a DRM-protected CAPTCHA®, a DRM-protected HTML div element, a DRM-protected image, etc. The first security element may be made to substantially match the background color of the media content based on Cascading Style Sheets (“CSS”) properties z-index and position.

The second layer may be generated to include a second security element, and the second security element may not be DRM-protected. The second security element may be a non-DRM-protected security element including at least one of a natural language message, an HTML div element, or a second user interface element. The natural language message may include a message to the user (e.g., user 105), such as a warning message (e.g., “Your data may be at risk”), a watermark (e.g., a watermarked image), etc. The HTML div element may be generated using the CSS properties z-index and position, such that the HTML div element substantially matches a background color of the media content (e.g., webpage, etc.). The second user interface element may be at least one of a button, a toggle, a CAPTCHA®, etc.

The third layer may be generated to include a background, e.g., a background associated with the media content (e.g., webpage). The third layer may be generated based on the formatting of the media content (e.g., webpage, website, etc.), such as the background design, color, opacity, etc. For example, if the media content background color is white, the third layer may be generated such that the third layer includes a white background.

At step 220, the at least two layered security elements associated with the sensitive information may be caused to be output (e.g., via GUI 112) based on the indication of sensitive information. In some embodiments, the at least two layered security elements may be caused to be output in a pre-determined order. For example, the at least two layered security elements may be caused to be output such that the first layer is overlaid on the second layer. In a further example, the at least two layered security elements may be caused to be output such that the first layer is overlaid on the second layer, and the second layer is overlaid on the third layer.

In other words, the at least two layered security elements may be caused to be output such that the DRM-protected first layer may be substantially visible (e.g., via GUI 112), and the non-DRM-protected second layer—and the background third layer, where applicable—may be substantially not visible.

Optionally, at step 225, it may be determined whether digital extraction is indicated. In some embodiments, the indication of digital extraction may be determined based on at least one indirect factor, such as user inputs, enabled settings, concurrently operating applications, mouse tracking, screenshare detection via CAPTCHA®, screenshare detection via button response, a screenshot detection script, a window focus event listener, a Development Tools (“DevTools”) event listener, a key to unlock, button blocking, entry randomization, field randomization, a refresh listener, a window resize monitor, etc. Mouse tracking may include detecting deviations from historical mouse behavior patterns. Examples of screenshare detection via CAPTCHA® and screenshare detection via button response are discussed in more detail below. A screenshot detection script may include utilizing a keylogging tool to understand if a suspicious actions may be occurring. A window focus event listener may include detecting changes in window focus. A DevTools event listener may include detecting whether DevTools was opened or used during a session (e.g., while user 105 is attempting to access sensitive information). Button blocking may include a custom button that may disappear (e.g., become transparent) when screenshare is active. Interactive elements remain intact if button blocking is in use. Entry randomization may include converting user inputs to randomized numbers or characters when screenshare is active. Field randomization may include randomizing or switching input fields when screenshare is active. A refresh listener may include determining if a page has been refreshed, or how many times a page may have been refreshed. A window resize monitor may include determining if a window may have been resized, which may indicate use of DevTools (e.g., the development console) or screenshare. For example, if a user input that may be indicative of screenshotting is detected, such as Zoom® operating on a user device (e.g., on user device 110) while a user (e.g., user 105) is accessing sensitive information, digital extraction may be indicated.

In some embodiments, a trained machine learning model may be configured to determine whether digital extraction is indicated. For example, the trained machine learning model may predict whether digital extraction is indicated based on the indication of sensitive information, the at least one indirect factor, the user input (e.g., the first user input, the second user input, etc.), etc.

As depicted in method 260 of FIG. 2B, at step 265, it may be determined that digital extraction is not indicated (e.g., via browser module 111). At step 266, a first user input associated with the first security element may be received (e.g., user 105 input via GUI 112). In some embodiments, if digital extraction is not indicated, the first layer and the associated first security element may be visible (e.g., may continue to be visible) (e.g., via GUI 112). For example, the first layer may be visible via GUI 112 such that the user (e.g., user 105) may be able to input a first user input to the DRM-protected security element associated with the first layer. At step 267, the first user input may be transmitted (e.g., via GUI 112 to application server 115, DRM-protection system 126, data storage 130, etc.).

At step 270, it may be determined that digital extraction is indicated (e.g., via browser module 111). At step 275, the second layer and the second security element may be dynamically generated based on the indication of digital extraction (e.g., via application server 115). In some embodiments, at least one layer of the at least two layered security elements may be dynamically generated upon receipt of the determination that digital extraction is indicated. For example, upon receipt of the determination that digital extraction is indicated, the second security element of the second layer may be generated to include a natural language warning message upon receipt of the indication of digital extraction.

In some embodiments, the second security element of the second layer may be modified based on the indication of digital extraction (e.g., via application server 115). For example, where the second layer has generated to include a second security element in the form of a CAPTCHA® (as discussed at step 215), the second security element may be dynamically modified (or generated) from including a CAPTCHA® to including a natural language message in response to the indication of digital extraction.

At step 276, the generated second layer or the generated second security element may be incorporated into the at least two layered security elements (e.g., via application server 115). The generated second layer may be incorporated into the at least two layered security elements such that when the first layer is modified (e.g., to be substantially transparent, as discussed below at step 230), the generated second layer or the generated second security element are substantially visible when caused to be output via a GUI (e.g., GUI 112).

In some embodiments, the previously included second layer (e.g., as generated at step 215) may be replaced with the generated second layer (e.g., as generated at step 275). For example, the generated second layer may be incorporated into the at least two layered security elements by replacing the previously included second layer (e.g., as generated at step 215) with the generated second layer and the associated generated second security element (e.g., as generated at step 275).

In some embodiments, the previously included second layer (e.g., as generated at step 215) may be replaced with the generated second security element (e.g., as generated at step 275). For example, the generated second security element may be incorporated into the at least two layered security elements by modifying the previously included second layer (e.g., as generated at step 215) to replace the previously included second security element with the generated second security element (e.g., as generated at step 275).

Alternatively or in addition to generating the second layer or second security element at step 275, upon receipt of the determination that digital extraction is indicated, at least one alert (e.g., a third alert) may be generated at step 280. In some embodiments, steps 275-276 and steps 280-282 may occur in series (e.g., steps 275-276 then steps 280-282 or steps 280-282 then steps 275-276) or in parallel (e.g., steps 275-276 and steps 280-282 occurring substantially simultaneously).

At step 280, upon receipt of the determination that digital extraction is indicated (see step 270), a third alert may be generated (e.g., via application server 115). In some embodiments, the third alert may be generated to include a natural language message that digital extraction may be indicated. As discussed in more detail below (see step 245), at least one alert may be generated based on the intended recipient. For example, the third alert may be generated based on the intended recipient being one or both of user 105 or third-party user 120.

At step 281, the third alert may be transmitted (e.g., via application server 115). In some embodiments, the third alert may be transmitted to at least one intended recipient, such as to user 105 (e.g., to GUI 112 of user device 110) or to third-party user 120 (e.g., to GUI 127 of third-party device 125). In some embodiments, the third alert may be transmitted to an analysis system (e.g., DRM-protection system 126). The third alert may be analyzed by DRM-protection system 126 to be utilized for down-stream measures (e.g., the at least one protective measure, as discussed in more detail in relation to step 245).

At step 282, the third alert may be caused to be output (e.g., via GUI 112, GUI 127, etc.). For example, where the third alert is intended for user 105, the third alert may be transmitted to user device 110 and may be caused to be output via GUI 112. In a further example, where the third alert is intended for third-party user 120, the third alert may be transmitted to third-party device 125 and may be caused to be output via GUI 127.

Returning to FIG. 2A, at step 230, the first layer may be modified upon receiving a determination that digital extraction is indicated. The operations may further include, upon determining digital extraction is indicated, modifying the first layer or associated first security element to be substantially transparent. For example, the first layer or associated first security element may be modified to be about 70%-80%, about 80%-90%, about 90%-99%, etc. transparent.

At step 235, the at least two layered security elements with the modified first layer may be caused to be output via a GUI (e.g., via GUI 112). In some embodiments, the at least two layered security elements with the modified first layer may be caused to be output such that the second layer or associated second security element are visible.

The second layer or associated second security element may be visible (e.g., via GUI 112) such that the user (e.g., user 105) may be able to input a second user input to the non-DRM-protected second security element associated with the second layer (e.g., via GUI 112) at step 240. The second user input (e.g., received via GUI 112) may be transmitted (e.g., to application server 115, DRM-protection system 126, data storage 130, etc.)

At step 245, based on the second user input, at least one alert (e.g., a first alert, a second alert, etc.) may be generated or at least one protective measure may be initiated. In some embodiments, the at least one alert may be generated (e.g., via application server 115 or DRM-protection system 126) based on the intended recipient. In some embodiments, the first alert may be generated based on the user (e.g., user 105) being the intended recipient. For example, the first alert may be generated to may be generated to include a natural language message for user 105 (e.g., “Your data may be at risk,” “Your information may be exposed,” etc.).

In some embodiments, the second alert may be generated based on the third-party user (e.g., third-party user 120) being the intended recipient. For example, the second alert may be generated to include a natural language message for user 120 (e.g., “User A's data may be compromised,” etc.).

In some embodiments, the third alert may be generated based on the intended recipient being one or both of user 105 or third-party user 120. For example, the third alert may be generated to include a natural language message for user 105 or user 120 (e.g., “Screenshotting is indicated,” etc.).

In some embodiments, the at least one alert may be generated (e.g., via application server 115 or DRM-protection system 126) based on the indication of digital extraction. For example, the second alert may be generated in response to receipt of the determination that digital extraction is indicated and transmitted to the third-party user (e.g., to third-party device 125 associated with third-party user 120). In a further example, the third alert may be generated to include a natural language message that digital extraction may be indicated, and transmitted to one or both of user 105 (e.g., to user device 110) or third-party user 120 (e.g., to third-party device 125).

In some embodiments, the at least one alert may be generated (e.g., via application server 115 or DRM-protection system 126) based on the at least one user input (e.g., a first user input, a second user input, etc.). In some embodiments, receipt of the second user input (associated with the second security element) may be indicative of digital extraction occurring. Where the second user input is received (e.g., via GUI 112), the second alert may be generated to indicate digital extraction may be indication (e.g., via a natural language message).

In some embodiments, the at least one protective measure may be initiated (e.g., via DRM-protection system 126) based on receipt of at least one user input (e.g., the second user input), the indication of digital extraction, the at least one alert (e.g., the first alert, the second alert, the third alert, etc.), etc. As discussed herein, the at least one protective measure may include at least one of pausing, locking, canceling, etc. an account (e.g., a financial account) associated with the sensitive information, pausing a current financial transaction, pausing subsequent financial transactions, transmitting the at least one alert (e.g., to GUI 112), etc. For example, where the content element represents a checking account number, the checking account associated with the checking account number may be locked (or frozen) as a precautionary measure upon receipt of the indication of digital extraction. In a further example, where a user (e.g. user 105) is attempting to authorize a wire transfer to a social engineer, the current financial transaction and subsequent financial transactions may be paused upon receipt of the second user input.

Optionally, at step 250, the at least one alert may be caused to be output. In some embodiments, the at least one alert may be output based on the user device to which it has been transmitted. For example, the first alert (having been transmitted to user device 110) may be caused to be output via a first GUI (e.g., GUI 112). In another example, the second alert (having been transmitted to third-party device 125) may be caused to be output via a second GUI (e.g., GUI 127). In a further example, the third alert may be caused to be output via one or both of the first GUI (e.g., GUI 112) or the second GUI (e.g., GUI 127), having been transmitted to one or both of user device 110 or third-party device 125, respectively.

### First Exemplary Embodiment

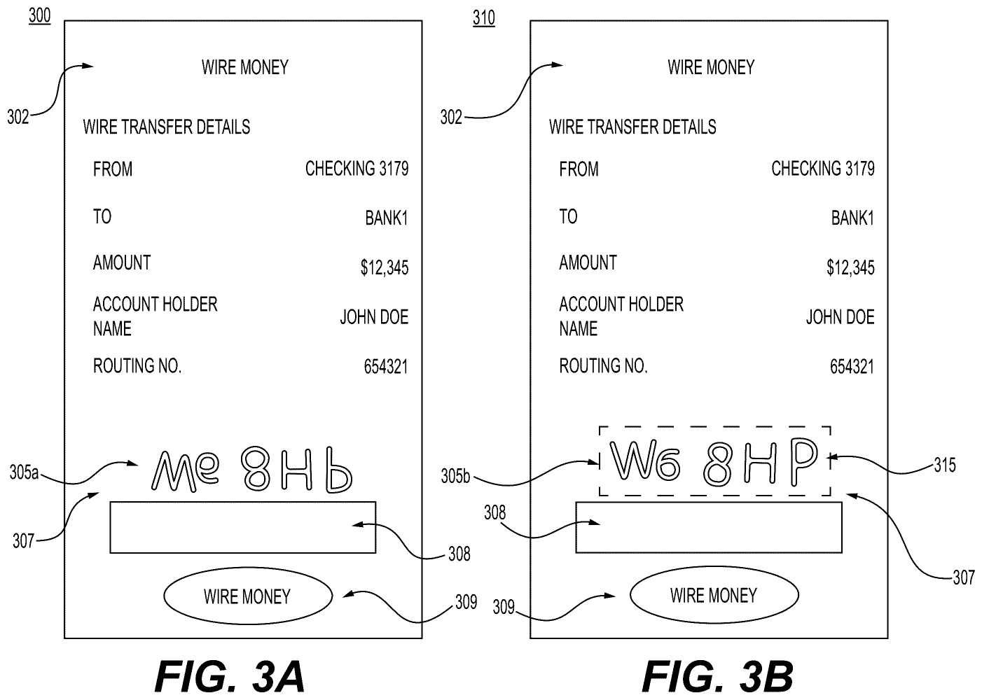

FIGS. 3A-3B depict exemplary schematics of a first embodiment for generating DRM-protected media via layered media, according to one or more embodiments. In the first exemplary embodiment, a user (e.g., user 105) may wish to initiate a wire transfer using a device enabled to utilize DRM protections (e.g., user device 110). The DRM protections associated with a webpage 302 may include the at least two layered security elements including a first layer and associated first security element, a second layer and associated second security element, and a third layer. The first layer may be overlaid on the second layer, and the second layer may be overlaid on the third layer.

FIG. 3A depicts the GUI output when digital extraction may not be indicated. As depicted in schematic 300, a first layer with first security element 305a of the at least two layered security elements may be visible (e.g., via GUI 112) on webpage 302. First security element 305a may include a DRM-protected CAPTCHA® element. The at least two layered security elements—and a first layer with first security element 305a—may be visible (e.g., via GUI 112) on webpage 302 in relation to a response input element 308 or an actuator 309. Causing to output first security element 305a in relation to response input element 308 or actuator 309 may protect the user (e.g., user 105) by providing DRM protections in relation to initiation of the wire transfer.

User 105 may input their response to first security element 305a (e.g., the DRM-protected CAPTCHA® element) via response input element 308. Because first security element 305a (and the DRM-protected CAPTCHA® element) are visible, user 105 may provide a response to the DRM-protected CAPTCHA® element via response input element 308. In some embodiments, the correct response may be the response that matches the DRM-protected CAPTCHA® element. The correct response may be stored (e.g., via data storage 130) to be compared to a response to the non-DRM-protected CAPTCHA® element. As such, when user 105 actuates actuator 309 based on their response to the DRM-protected CAPTCHA® element, the wire transfer may be authorized.

However, where digital extraction is indicated, DRM protections may be initiated, as depicted in FIG. 3B. As depicted in schematic 310, when digital extraction is indicated, the first layer with first security element 305a of the at least two layered security elements may be modified (see step 230 of FIG. 2A) such that it becomes a substantially transparent first security element 305b and may not be visible (e.g., via GUI 112) on webpage 302. A second layer with second security element 315 of the at least two layered security elements may be visible (e.g., via GUI 112) on webpage 302 from beneath substantially transparent first security element 305b. Second security element 315 may include a non-DRM-protected CAPTCHA® element.

User 105 may input their response to second security element 315 (e.g., the non-DRM-protected CAPTCHA® element) via response input element 308. Because second security element 315 (and the non-DRM-protected CAPTCHA® element) are visible, user 105 may provide a response based on the non-DRM-protected CAPTCHA® element via response input element 308. In some embodiments, the correct response may be the response that matches the DRM-protected CAPTCHA® element, so a response that matches the non-DRM-protected CAPTCHA® element may be incorrect when compared to the correct response. As such, when user 105 actuates actuator 309 based on their response to the non-DRM-protected CAPTCHA® element, the wire transfer may be rejected. In some embodiments, at least one alert may be generated based on one or both of the response to the DRM-protected CAPTCHA® element or the response to the non-DRM-protected CAPTCHA® element (see step 245 of FIG. 2A). In some embodiments, at least one protective measure may be initiated based on the response to the non-DRM-protected CAPTCHA® element (see step 245 of FIG. 2A).

### Second Exemplary Embodiment

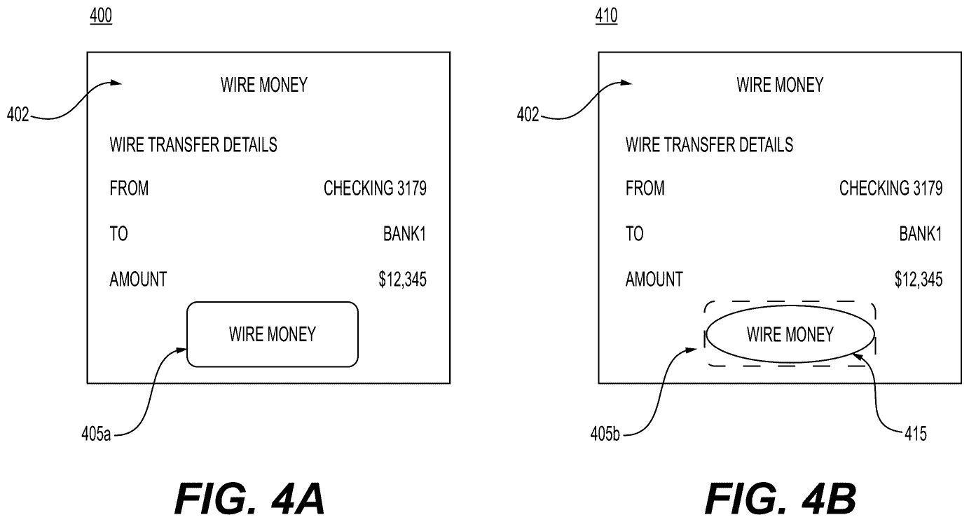

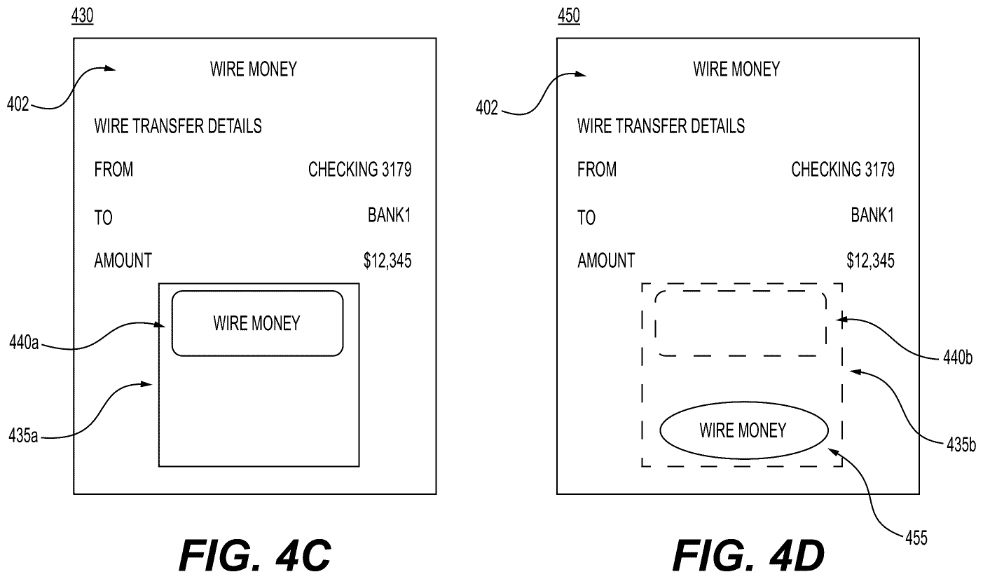

FIGS. 4A-4D depict exemplary schematics of a second embodiment for generating DRM-protected media via layered media, according to one or more embodiments. In the second exemplary embodiment, a user (e.g., user 105) may wish to initiate a wire transfer using a device enabled to utilize DRM protections (e.g., user device 110). The DRM protections associated with a webpage 402 may include the at least two layered security elements, including a first layer and associated first security element, and a second layer and associated second security element. The first layer may be overlaid on the second layer.

FIG. 4A depicts the GUI output when digital extraction may not be indicated. As depicted in schematic 400, a first layer with first security element 405a of the at least two layered security elements may be visible (e.g., via GUI 112) on webpage 402. First security element 405a may include a true actuator. The true actuator may be an actuator configured to enable the wire transfer.

User 105 may input (e.g., via GUI 112) a first actuation input (e.g., clicking, hovering, selecting, etc.) in relation to first security element 405a. Because first security element 405a is visible and selectable, user 105 may be able to actuate the true actuator of first security element 405a, thereby authorizing the wire transfer.

However, where digital extraction is indicated, DRM protections may be initiated, as depicted in FIG. 4B. As depicted in schematic 410, when digital extraction is indicated, the first layer with first security element 405a of the at least two layered security elements may be modified (see step 230 of FIG. 2A) such that it becomes a substantially transparent first security element 405b and may not be visible (e.g., via GUI 112) on webpage 402. A second layer with second security element 415 of the at least two layered security elements may be visible (e.g., via GUI 112) on webpage 402 from beneath substantially transparent first security element 405b. Second security element 415 may include a false actuator. The false actuator may be an actuator that is not configured to enable to wire transfer. In some embodiments, the false actuator may be configured to generate at least one alert when actuated. In some embodiments, actuating the false actuator may initiate an onClick JavaScript® event (e.g., generating at least one alert or initiating the at least one protective measures, as discussed herein). Implementation of the second exemplary embodiment—or any embodiment described herein—via JavaScript® may enable use of the embodiment(s) across a wide range of web applications, enable compliance with digital accessibility standards (e.g., the Web Content Accessibility Guidelines (“WCAG”)), or facilitate adaptation to popular frontend libraries and frameworks (e.g., React®, Angular®, etc.), which may enable developers to integrate the embodiment(s) described herein into more complex and dynamic web applications.

User 105 may input (e.g., via GUI 112) a second actuation input (e.g., clicking, hovering, selecting, etc.) in relation to second security element 415. Because first security element 405a is neither visible nor selectable, user 105 may actuate the false actuator of second security element 415, and the wire transfer may be rejected. Causing to output second security element 415 when digital extraction is indicated may protect the user (e.g., user 105) by providing DRM protections in relation to initiation of the wire transfer. In some embodiments, at least one alert may be generated based on one or both of the first actuation input or the second actuation input (see step 245 of FIG. 2A). In some embodiments, at least one protective measure may be initiated based on the second actuation input (see step 245 of FIG. 2A).

### Third Exemplary Embodiment

FIGS. 4C-4D depict exemplary schematics of a third embodiment for generating DRM-protected media via layered media, according to one or more embodiments. Similar to the second embodiment, in the third embodiment, a user (e.g., user 105) may wish to initiate a wire transfer using a device enabled to utilize DRM protections (e.g., user device 110). The DRM protections associated with a webpage 402 may include the at least two layered security elements, including a first layer and associated first security element, and a second layer and associated second security element. The first layer may be overlaid on the second layer.

FIG. 4B depicts the GUI output when digital extraction may not be indicated. As depicted in schematic 430, a first layer 435a with a first security element 440a of the at least two layered security elements may be visible (e.g., via GUI 112) on webpage 402. First security element 440a may include a true actuator. The true actuator may be an actuator configured to enable the wire transfer.

User 105 may input (e.g., via GUI 112) a first actuation input (e.g., clicking, hovering, selecting, etc.) in relation to first security element 440a. Because first security element 440a is visible and selectable, user 105 may be able to actuate the true actuator of first security element 440a, thereby authorizing the wire transfer.

However, where digital extraction is indicated, DRM protections may be initiated, as depicted in FIG. 4D. As depicted in schematic 450, when digital extraction is indicated, first layer 435a and first security element 440a of the at least two layered security elements may be modified (see step 230 of FIG. 2A) such that they become a substantially transparent first layer 435b and a substantially transparent first security element 440b, respectively, and may not be visible (e.g., via GUI 112) on webpage 402. A second layer with second security element 455 of the at least two layered security elements may be visible (e.g., via GUI 112) on webpage 402 from beneath substantially transparent first security element 440b. Second security element 455 may include a false actuator. The false actuator may be an actuator that is not configured to enable to wire transfer. In some embodiments, the false actuator may be configured to generate at least one alert when actuated.

User 105 may input (e.g., via GUI 112) a second actuation input (e.g., clicking, hovering, selecting, etc.) in relation to second security element 455. As depicted in FIG. 4C, first layer 435a may be configured such that first security element 440b and second security element 455 are not overlapping (e.g., first security element 440b is not overlaid on second security element 455). As such, when user 105 provides an actuation input to second security element 455, as depicted in FIG. 4D, the second actuation input associated with second security element 455 may be associated with different actuation input data (e.g., the location of the input) than the first actuation input associated with first security element 440a. Because first security element 440a is neither visible nor selectable, user 105 may actuate the false actuator of second security element 455, and the wire transfer may be rejected.

Causing to output second security element 455 when digital extraction is indicated may protect the user (e.g., user 105) by providing DRM protections in relation to initiation of the wire transfer. In some embodiments, at least one alert may be generated based on one or both of the first actuation input or the second actuation input (see step 245 of FIG. 2A). In some embodiments, at least one protective measure may be initiated based on the second actuation input (see step 245 of FIG. 2A).

### Fourth Exemplary Embodiment

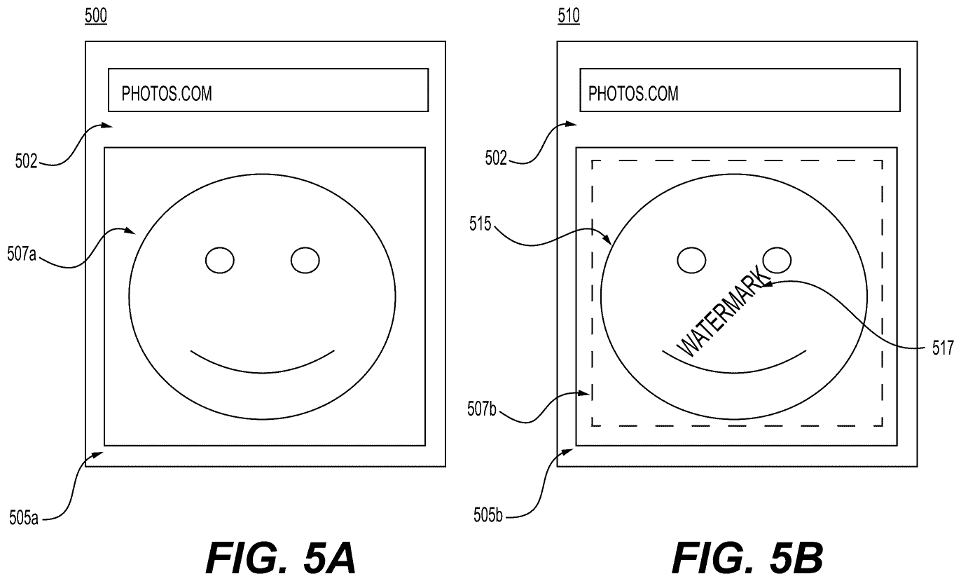

FIGS. 5A-5B depict exemplary schematics of a fourth embodiment for generating DRM-protected media via layered media, according to one or more embodiments. In the fourth exemplary embodiment, a user (e.g., user 105) may wish to share media (e.g., screenshare an image) without the image being stolen (e.g., via screenshotting) using a device enabled to utilize DRM protections (e.g., user device 110). The DRM protections associated with a webpage 502 may include the at least two layered security elements, including a first layer and a second layer. The first layer may be overlaid on the second layer.

FIG. 5A depicts the GUI output when digital extraction may not be indicated. As depicted in schematic 500, a first layer 505a with first security element 507a of the at least two layered security elements may be visible (e.g., via GUI 112) on webpage 402. First security element 507a may include an unedited image. Where digital extraction is not indicated, the unedited image of first security element 507a may be caused to be output (e.g., via GUI 112).

However, where digital extraction is indicated, DRM protections may be initiated, as depicted in FIG. 5B. As depicted in schematic 510, when digital extraction is indicated, first layer 505a with first security element 507a of the at least two layered security elements may be modified (see step 230 of FIG. 2A) such that it becomes a substantially transparent first layer 505b and a substantially transparent first security element 507b. Substantially transparent first layer 505b and substantially transparent first security element 507b may not be visible (e.g., via GUI 112) on webpage 402. A second layer with second security element 515 of the at least two layered security elements may be visible (e.g., via GUI 112) on webpage 502 from beneath substantially transparent first security element 507b. Second security element 515 may be an image edited to include a watermark 517. Watermark 517 may be configured to identify an owner (e.g., user 105), prevent unauthorized duplication (e.g., digital extraction), or add a decorative effect. Causing to output second security element 515 when digital extraction is indicated may protect the user (e.g., user 105) by providing DRM protections in relation to sharing media. As such, the user (e.g., user 105) may be able to protect their media from being duplicated without permission, thereby protecting a user's intellectual property, such as copyrights.

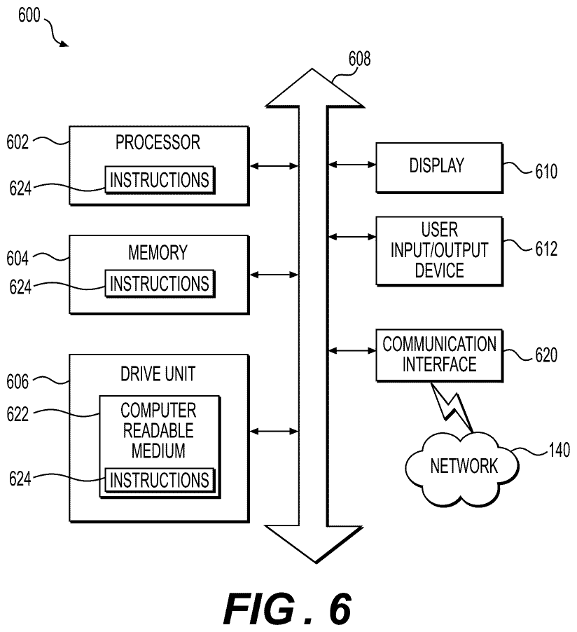

FIG. 6 depicts a simplified functional block diagram of a computer 600 that may be configured as a device for executing the methods disclosed here, according to exemplary embodiments of the present disclosure. For example, the computer 600 may be configured as a system according to exemplary embodiments of this disclosure. In various embodiments, any of the systems herein may be a computer 600 including, for example, a data communication interface 620 for packet data communication. The computer 600 also may include a central processing unit (CPU) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications. The computer 600 may also have a memory 604 (such as RAM) storing instructions 624 for executing techniques presented herein, although the instructions 624 may be stored temporarily or permanently within other modules of computer 600 (e.g., processor 602 or computer readable medium 622). The computer 600 also may include input and output ports 612 or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating digital rights management (“DRM”)-protected layered media, the method comprising:
receiving, via a browser module, an indication of sensitive information, the indication of sensitive information having been determined based on a content element;
based on the indication of sensitive information, causing to output at least two layered security elements associated with the sensitive information, the at least two layered security elements including at least a first layer associated with a first security element and a second layer associated with a second security element;
determining, via a browser module, digital extraction is indicated;
upon determining digital extraction is indicated, modifying the first layer such that the first layer and the associated first security element are substantially transparent; and
causing to output, via a first graphical user interface (“GUI”), the at least two layered security elements with the modified first layer, such that the second layer and the associated second security element are substantially visible.

2. The method of claim 1, further comprising:
receiving a first user input associated with the first security element; and
transmitting the first user input to a data storage system.

3. The method of claim 1, further comprising:
receiving a second user input associated with the second security element;
transmitting the second user input to an analysis system;
based on the second user input, generating a first alert via the analysis system; and
causing to output the first alert via the first.

4. The method of claim 1, further comprising:
receiving a second user input associated with the second security element;
transmitting the second user input to an analysis system;
based on the second user input, generating a second alert via the analysis system; and
causing to output the second alert via a second GUI associated with the analysis system.

5. The method of claim 1, further comprising:
receiving a second user input associated with the second security element;
transmitting the second user input to an analysis system; and
based on the second user input, initiating at least one protective measure via the analysis system.

6. The method of claim 5, wherein the at least one protective measure includes at least one of pausing a current transaction, pausing subsequent transactions, or locking an account associated with the sensitive information.

7. The method of claim 1, wherein the at least two layered security elements further includes a third layer including media content background.

8. The method of claim 7, wherein the first security element is a DRM-protected security element including at least one of a single frame-looped video that substantially matches formatting associated with the media content background of the third layer or a first user interface element.

9. The method of claim 1, wherein the second security element is a non-DRM-protected security element including at least one of a natural language message, a HyperText Markup Language div element, second user interface element, or a Completely Automated Public Turing test to tell Computers and Humans Apart (“CAPTCHA”).

10. The method of claim 1, further comprising:
upon determining digital extraction is indicated, dynamically generating, via an application server, the second security element based on the indication of digital extraction;
transmitting, via the application server, the second security element to the browser module;
dynamically generating, via the browser module, the second layer based on the second security element; and
incorporating the generated second layer into the at least two layered security elements such that when the first layer is modified, the generated second layer and the associated second security element are substantially visible when caused to be output via the first GUI.

11. The method of claim 1, further comprising:
upon determining digital extraction is indicated, generating a third alert based on the indication of digital extraction;
transmitting the third alert to at least one of a user device or an analysis system; and
causing to output the third alert via at least one of the first GUI or a second GUI associated with the analysis system, wherein the first GUI is associated with the user device.

12. A system, the system comprising:
at least one memory storing instructions; and
at least one processor operatively connected to the memory, and configured to execute the instructions to perform operations for generating digital rights management (“DRM”)-protected layered media, the operations including:
receiving, via a browser module, an indication of sensitive information, the indication of sensitive information having been determined based on a content element;
based on the indication of sensitive information, causing to output at least two layered security elements associated with the sensitive information, the at least two layered security elements including at least a first layer associated with a first security element and a second layer associated with a second security element;
determining, via a browser module, digital extraction is indicated;
upon determining digital extraction is indicated, modifying the first layer such that the first layer and the associated first security element are substantially transparent; and
causing to output, via a first graphical user interface (“GUI”), the at least two layered security elements with the modified first layer, such that the second layer and the associated second security element are substantially visible.

13. The system of claim 12, the operations further comprising:
receiving a second user input associated with the second security element;
transmitting the second user input to an analysis system;
based on the second user input, generating a first alert via the analysis system; and
causing to output the first alert via the first GUI.

14. The system of claim 12, the operations further comprising:
receiving a second user input associated with the second security element;
transmitting the second user input to an analysis system;
based on the second user input, generating a second alert via the analysis system; and
causing to output the second alert via a second GUI associated with the analysis system.

15. The system of claim 12, the operations further comprising:
receiving a second user input associated with the second security element;
transmitting the second user input to an analysis system; and
based on the second user input, initiating at least one protective measure via the analysis system, wherein the at least one protective measure includes at least one of pausing a current transaction, pausing subsequent transactions, or locking an account associated with the sensitive information.

16. The system of claim 12, wherein the at least two layered security elements further includes a third layer including media content background.

17. The system of claim 16, wherein:
the first security element is a DRM-protected security element including at least one of a single frame-looped video that substantially matches formatting associated with the media content background of the third layer or a first user interface element; and
the second security element is a non-DRM-protected security element including at least one of a natural language message, a HyperText Markup Language div element, second user interface element, or a Completely Automated Public Turing test to tell Computers and Humans Apart (“CAPTCHA”).

18. The system of claim 12, the operations further comprising:
upon determining digital extraction is indicated, dynamically generating, via an application server, the second security element based on the indication of digital extraction;
transmitting, via the application server, the second security element to the browser module;
dynamically generating, via the browser module, the second layer based on the second security element; and
incorporating the generated second layer into the at least two layered security elements such that when the first layer is modified, the generated second layer and the associated second security element are substantially visible when caused to be output via the first GUI.

19. The system of claim 12, the operations further comprising:
upon determining digital extraction is indicated, generating a third alert based on the indication of digital extraction;
transmitting the third alert to at least one of a user device or an analysis system; and
causing to output the third alert via at least one of the first GUI or a second GUI associated with the analysis system, wherein the first GUI is associated with the user device.

20. A method for generating digital rights management (“DRM”)-protected layered media, the method comprising:
receiving, via a browser module, an indication of sensitive information, the indication of sensitive information having been determined based on a content element;
based on the indication of sensitive information, causing to output at least two layered security elements associated with the sensitive information, the at least two layered security elements including:
a first layer associated with a first security element, wherein the first security element is a DRM-protected security element including at least one of a single frame-looped video that substantially matches formatting associated with a media content background or a first user interface element,
a second layer associated with a second security element, wherein the second security element is a non-DRM-protected security element including at least one of a natural language message, a HyperText Markup Language div element, second user interface element, or a Completely Automated Public Turing test to tell Computers and Humans Apart (“CAPTCHA”), and
a third layer including the media content background;
determining, via a browser module, digital extraction is indicated;
upon determining digital extraction is indicated, dynamically generating the second security element based on the indication of digital extraction via the browser module, wherein the generated second security element is incorporated into the second layer;
upon determining digital extraction is indicated, modifying the first layer such that the first layer and the associated first security element are substantially transparent;
causing to output, via a first graphical user interface (“GUI”), the at least two layered security elements with the modified first layer, such that the second layer and the associated second security element are substantially visible;
receiving a user input associated with the second security element;
transmitting the user input to an analysis system; and
based on the user input, initiating at least one protective measure via the analysis system, wherein the at least one protective measure includes at least one of pausing a current transaction, pausing subsequent transactions, or locking an account associated with the sensitive information.
